(19) United States
(12) Patent Application Publication
(10) Pub. No.: US 2026/0366209 A1
(43) Pub. Date: Nov. 19, 2026

(54) ELECTROMAGNETIC STEPPING THREE-DIMENSIONAL ROTARY BRAIDING MACHINE AND CONTROL METHOD

(71) Applicant: NANJING UNIVERSITY OF AERONAUTICS AND ASTRONAUTICS, Jiangsu (CN)

(72) Inventors: Zhongde SHAN, Jiangsu (CN); Zheng SUN, Jiangsu (CN); Zhengxi ZHOU, Jiangsu (CN); Zitong GUO, Jiangsu (CN)

(21) Appl. No.: 19/133,698

(22) PCT Filed: Sep. 20, 2024
(86) PCT No.: PCT/CN2024/119966

§ 371 Date: May 28, 2025

(30) Foreign Application Priority Data
Sep. 20, 2023 (CN) 202311215005.1

(51) Int. Cl. D04C 3/24; D04C 3/18; D04C 3/38

(52) U.S. Cl. CPC D04C 3/24; D04C 3/18; D04C 3/38

(57) ABSTRACT

An electromagnetic stepping three-dimensional rotary braiding machine includes a braiding machine chassis and a motion mechanism thereof, an electromagnetic auxiliary system, a fabric traction device, and an electronic control system. The motion mechanism of the braiding machine chassis is composed of cross-shaped forks disposed adjacent to each other, and is used for driving yarn carriers to move in a specific pattern. The electromagnetic auxiliary system is used for achieving position transfer and stopping of the yarn carriers between motion components. The fabric traction device is used for lifting a woven fabric at a certain speed. The electronic control system is used for issuing and transmitting a motion instruction for the yarn carriers. The braiding machine uses the electromagnetic auxiliary system to control movement and stopping of the yarn carriers.

### TECHNICAL FIELD

The present disclosure relates to the technical field of braiding machines, and in particular to an electromagnetic stepping three-dimensional rotary braiding machine and a control method.

### RELATED ART

Three-dimensional (3D) braided fabrics can be used as reinforcements for composite materials, and can be near-net formed due to their structural stability and design flexibility. They have been successfully applied in the fields of aerospace, rail transportation, automobile and ships, and the 3D braiding forming technology and equipment have also witnessed significant development.

In the 3D braiding forming technology, a braiding machine drives yarn carriers loaded with yarns to interlace the yarns, thereby forming a 3D braided preform with a spatial network structure. The 3D braided preform can be made using determinant 3D braiding machines and rotary 3D braiding machines. The rotary 3D braiding machines achieve the interlacing of yarns by rotating chassis components to drive the yarn carriers in a cyclic motion, and can be classified into continuous rotary braiding machines and stepping rotary braiding machines.

Rotational components of the stepping rotary braiding machines have action timing, and are capable of digitally controlling motion trajectories of the yarn carriers, making them more suitable for forming 3D braided preforms with complex cross-sections. However, the existing stepping rotary 3D braiding machines used for preparing 3D braided preforms are difficult to control effectively due to their complex structures, collisions and interferences between moving components during operation, which results in a high failure rate and affects the braiding efficiency, consequently limiting further promotion and application of the machines in the engineering field.

### SUMMARY OF INVENTION

In view of defects in the prior art, the present disclosure provides an electromagnetic stepping three-dimensional rotary braiding machine to achieve efficient forming of three-dimensional (3D) braided preforms with complex cross-sections.

The present disclosure further provides a control method for the electromagnetic stepping three-dimensional rotary braiding machine.

In order to achieve the above objectives, the electromagnetic stepping three-dimensional rotary braiding machine of the present disclosure adopts the following technical solution:
an electromagnetic stepping three-dimensional rotary braiding machine, including an upper support plate, a plurality of cross-shaped forks mounted on the support plate, a drive mechanism for driving the cross-shaped forks to rotate, and a plurality of yarn carrier assemblies cooperating with the cross-shaped forks; where the plurality of cross-shaped forks are evenly mounted in rows and columns on the upper support plate, each cross-shaped fork includes a central rotating shaft perpendicular to a surface of the upper support plate and inserted into the upper support plate, and finger portions extending from the central rotating shaft in four directions; each finger portion is an electromagnet structure and is independently controlled for power supply; the drive mechanism is configured to drive all the cross-shaped forks to rotate simultaneously, and rotation directions of two adjacent cross-shaped forks are opposite; each yarn carrier assembly includes a yarn carrier base and a yarn carrier mounted on the yarn carrier base, and a support post made of ferromagnetic material is disposed at a center of the yarn carrier base to cooperate with the finger portion; and when the finger portions of the cross-shaped fork are energized, magnetic force is generated to attract the support post, thereby driving the yarn carrier base to rotate.

Further, a plurality of guide grooves are formed on the upper support plate, one guide groove is arranged between every two adjacent cross-shaped forks, and one guide electromagnet is arranged at a bottom of each guide groove. When the finger portions of the cross-shaped fork are energized, the support post is driven to rotate to a position facing the guide groove, the guide electromagnet is energized to generate magnetic force greater than that of the finger portions, thereby attracting the support post into the guide groove.

Further, the drive mechanism includes a motor located below the upper support plate and a plurality of gear shafts arranged in rows and columns and parallel to one another; and one gear shaft is coaxially connected to the central rotating shaft of one corresponding cross-shaped fork, each gear shaft is provided with one gear, two adjacent gears in each row or each column mesh with each other, and one of the gear shafts is connected to a motor output shaft as a driving gear shaft.

Further, the electromagnetic stepping three-dimensional rotary braiding machine also includes a fabric traction device located above the yarn carrier assemblies for pulling yarn wound on the yarn carrier assemblies.

Further, the yarn carrier base further includes an upper mounting block and a lower sliding block, the support post is located between the upper mounting block and the lower sliding block, and a bottom surface of the lower sliding block has a boat-bottom shape with a lower middle section and gradually raised ends, so as to match the guide groove.

Further, the support post is cylindrical, and a front end of each finger portion is an arc-shaped recess adapted to the cylindrical support post.

Further, the electromagnetic stepping three-dimensional rotary braiding machine also includes a lower support plate located below the upper support plate, a bottom of each gear shaft is mounted on the lower support plate via bearings, support shafts are arranged between the upper support plate and the lower support plate, bottoms of the support shafts are fixed to the lower support plate, tops of the support shafts are fixed to the upper support plate, and a through hole is formed in a center of each support shaft for introducing an axial yarn.

Based on the traditional stepping three-dimensional rotary braiding machine, the present disclosure provides an electromagnetic stepping three-dimensional rotary braiding machine to control motion and stopping of the yarn carriers by means of electromagnetic attraction. The braiding machine can replace the traditional stepping three-dimensional rotary braiding machines in which the motion of yarn carriers is driven by the linkage of angle wheels and the dials. Compared with conventional stepping rotary braiding machines, the braiding machine of the present disclosure has a simplified mechanical structure and transmission mode, thereby reducing a degree of frictional contact and failure rate among motion components, and it is easy to achieve automated and digitalized formation of complex-structured three-dimensional braided fabrics.

The present disclosure further provides technical solutions for a control method for the electromagnetic stepping three-dimensional rotary braiding machine. One optional technical solution includes the following steps:
S1. arranging yarn carrier assemblies on an upper support plate according to the braiding requirements;
S2. activating an electromagnetic structure of one finger portion to attract the yarn carrier assemblies;
S3. driving all cross-shaped forks to rotate by 90° simultaneously;
S4. de-energizing the electromagnet structure of the energized finger portion in the step S2, and energizing the electromagnet structure of the finger portion of another cross-shaped fork adjacent to the de-energized one until the yarn carrier assemblies slide toward the energized finger portion;
S5. raising a fabric height according to the fabric structural design requirements; and
S6. repeating the above mechanical steps in a predefined trajectory by the braiding machine to form a fabric structure.

Another optional technical solution for the control method includes the following steps:
S1. arranging yarn carrier assemblies on an upper support plate according to the braiding requirements;
S2. activating an electromagnetic structure of one finger portion to attract the yarn carrier assemblies;
S3. driving all cross-shaped forks to rotate by 90° simultaneously;
S4. activating an electromagnet in a guide groove until the yarn carrier assemblies slide from the finger portion into the guide groove;
S5. de-energizing the electromagnet structure of the energized finger portion in the step S2, and energizing the electromagnet structure of the finger portion of another cross-shaped fork adjacent to the de-energized one until the yarn carrier assemblies slide toward the energized finger portion;
S6. raising a fabric height according to the fabric structural design requirements; and
S7. repeating the above mechanical steps in a predefined trajectory by the braiding machine to form a fabric structure.

Further, the fabric height in the step S6 is constrained by the following equation:

$$v = \frac{H}{( \frac{0.5 π}{W} + Δ {T}_{1} + Δ {T}_{2} )}$$

where v denotes a fabric lifting speed of the fabric traction device 1, H denotes a fabric pitch height, W denotes a rotation angular velocity of the cross-shaped fork 10, ΔT₁ denotes a time duration during which an electromagnet structure of the finger portion is energized to generate magnetic force, and ΔT₂ denotes a time duration during which an electromagnet in one guide groove is energized to generate magnetic force.

### BRIEF DESCRIPTION OF DRAWINGS

FIG. 1 is an overall schematic diagram of an electromagnetic stepping three-dimensional rotary braiding machine according to the present disclosure.

FIG. 2 is a schematic diagram of a braiding machine chassis and a motion mechanism according to the present disclosure.

FIG. 3 is a top view of a motion mechanism and an electromagnetic auxiliary system of a braiding machine according to the present disclosure.

FIG. 4 is an oblique side view of a motion mechanism and an electromagnetic auxiliary system of a braiding machine according to the present disclosure.

FIG. 5 is a schematic diagram of a yarn carrier base of a braiding machine according to the present disclosure.

FIG. 6 is a schematic diagram of a yarn carrier base of a braiding machine and a yarn carrier thereof according to the present disclosure.

FIG. 7 is a schematic diagram showing motion of a yarn carrier assembly during a braiding process of a braiding machine according to the present disclosure, and shows a state that the yarn carrier assembly is attracted by a first finger portion.

FIG. 8 is a schematic diagram showing motion of a yarn carrier assembly during a braiding process of a braiding machine according to the present disclosure, and shows a state that the yarn carrier assembly is rotated by 90° by a first finger portion.

FIG. 9 is a schematic diagram showing motion of a yarn carrier assembly during a braiding process of a braiding machine according to the present disclosure, and shows a state that the yarn carrier assembly is attracted by an electromagnet in a guide groove and enters the guide groove;

FIG. 10 is a schematic diagram showing motion of a yarn carrier assembly during a braiding process of a braiding machine according to the present disclosure, and shows a state that the yarn carrier assembly is attracted by a second finger portion adjacent to a first finger portion.

FIG. 11 is a perspective view of motion of the yarn carrier assembly shown in FIG. 7 to FIG. 10 integrated in a same figure.

FIG. 12 is a schematic diagram showing a coverage area of trajectory of a yarn carrier according to the present disclosure.

### DESCRIPTION OF EMBODIMENTS

The present disclosure will be further described below with reference to the accompanying drawings and the particular embodiments.

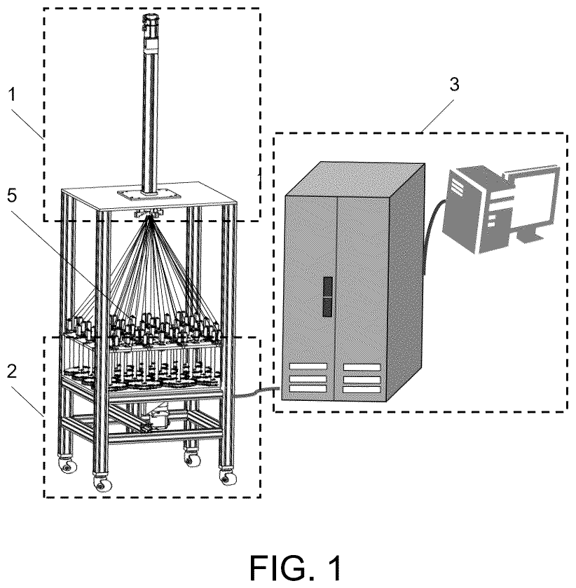

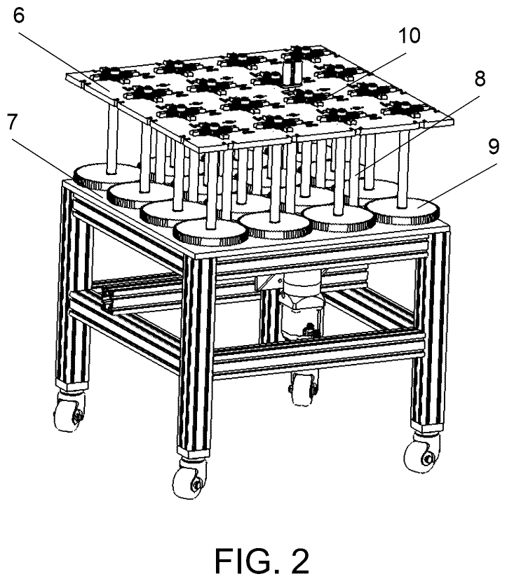

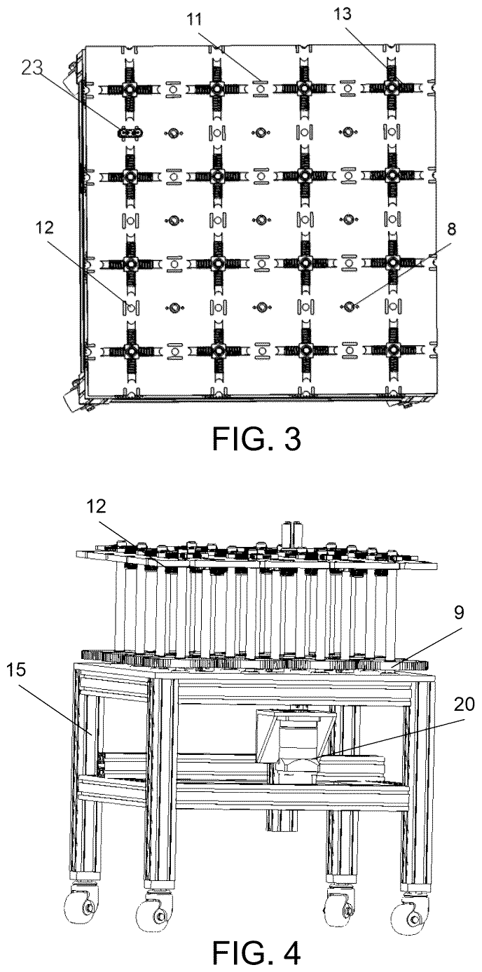

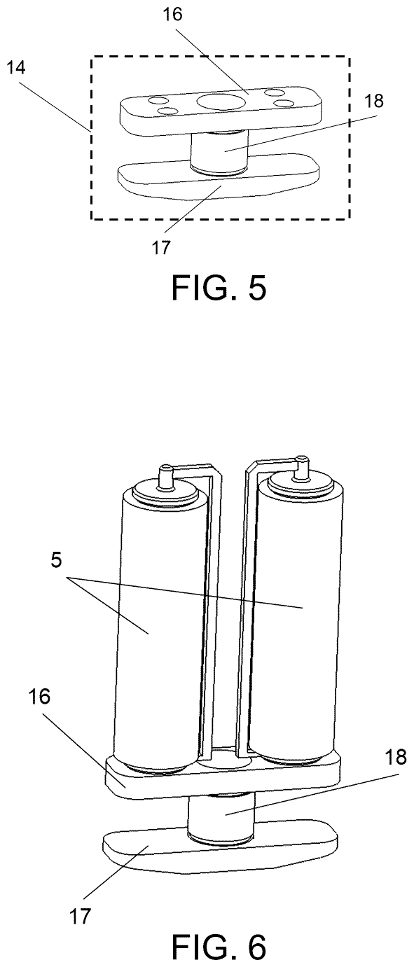

Referring to FIG. 1 to FIG. 4, the present disclosure provides an electromagnetic stepping three-dimensional rotary braiding machine, including a braiding machine chassis 2, a fabric traction device 1, and an electronic control system 3. The fabric traction device 1 is configured to lift a braided fabric at a certain speed. The electronic control system 3 is configured to issue and transmit a motion instruction for yarn carriers 5, thereby realizing digital control of the yarn carrier motion trajectory.

A structural improvement of a motion control mechanism for the yarn carriers 5 on the braiding machine chassis 2 is the key improvement of the present disclosure over the prior art. The braiding machine chassis 2 includes an upper support plate 6, a plurality of cross-shaped forks 10 mounted on the support plate, a drive mechanism for driving the cross-shaped forks 10 to rotate, and a plurality of yarn carrier assemblies 23 cooperating with the cross-shaped forks 10.

The plurality of cross-shaped forks 10 are evenly mounted in rows and columns on the upper support plate 6, each cross-shaped fork 10 includes a central rotating shaft 19 perpendicular to a surface of the upper support plate 6 and inserted into the upper support plate 6, and finger portions 22 extending from the central rotating shaft 19 in four directions. Each finger portion 22 is an electromagnet structure and is independently controlled for power supply. In this embodiment, the four finger portions 22 of each cross-shaped fork 10 extend perpendicularly to one another, thereby forming a “cross” shape. The drive mechanism is configured to drive all the cross-shaped forks 10 to rotate simultaneously, and rotation directions of two adjacent cross-shaped forks 10 are opposite. The electromagnet structure is as follows: each finger portion that is made of ferromagnetic material and is sleeved with an energizable solenoid 13.

Each yarn carrier assembly 23 includes a yarn carrier base 14 and the yarn carrier 5 mounted on the yarn carrier base, and a support post 18 made of ferromagnetic material is disposed at a center of the yarn carrier base 14 to cooperate with the finger portions 22; and when the finger portions 22 of the cross-shaped forks 10 are energized, magnetic force is generated to attract the support post 18, thereby driving the yarn carrier base 14 to rotate.

The drive mechanism includes a motor located below the upper support plate 6 and a plurality of gear shafts arranged in rows and columns and parallel to one another; and one gear shaft is coaxially connected to the central rotating shaft 19 of one corresponding cross-shaped fork 10, each gear shaft is provided with one gear 9, two adjacent gears in each row or each column mesh with each other, and one of the gear shafts is connected to a motor output shaft as a driving gear shaft. In order to carry the gear shafts, this embodiment further includes a lower support plate 7 located below the upper support plate 6, a bottom of each gear shaft is mounted on the lower support plate 7 via bearings, support shafts are arranged between the upper support plate and the lower support plate, bottoms of the support shafts 8 are fixed to the lower support plate 7, tops of the support shafts 8 are fixed to the upper support plate 6, and a through hole is formed in a center of each support shaft 8 for introducing an axial yarn.

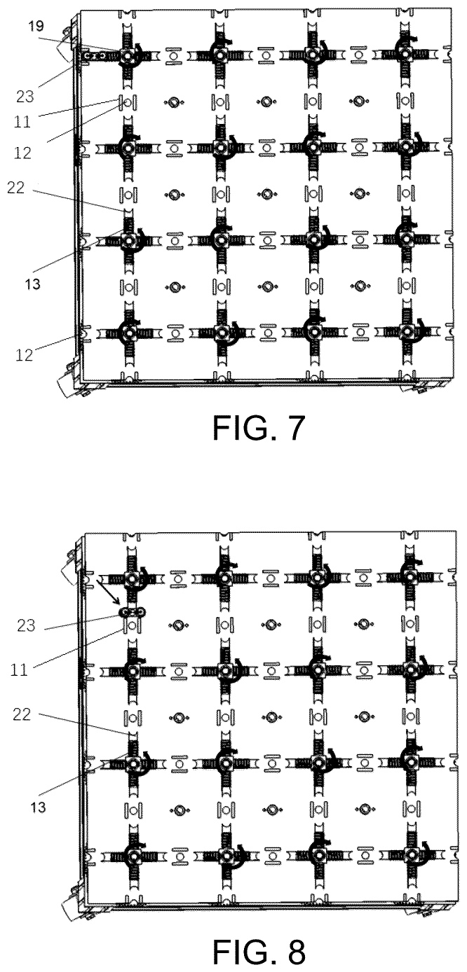

As shown in FIG. 7, in a further improvement, a plurality of guide grooves 11 are formed on the upper support plate 6, one guide groove is arranged between every two adjacent cross-shaped forks 10, and one guide electromagnet 12 is arranged at a bottom of each guide groove. When the finger portions 22 of the cross-shaped fork 10 are energized, the support post 18 is driven to rotate to a position facing the guide groove, the guide electromagnet 12 is energized to generate magnetic force greater than that of the finger portions 22, thereby attracting the support post 18 into the guide groove. The guide groove 11, as an intermediate structure between the two adjacent cross-shaped forks 10, can provide a positioning and parking device for an intermediate trajectory of the yarn carrier assembly 23 when it moves between the two adjacent cross-shaped forks 10, to prevent deviation of the yarn carrier assembly 23. In addition, a plurality of the guide grooves 11 and the corresponding guide electromagnets 12 are also arranged on four edges of an upper surface of the upper support plate 6. When the finger portions 22 of the outermost cross-shaped forks 10 drive the yarn carrier assemblies 23 to the four edges of the upper surface of the upper support plate 6, the guide grooves 11 and the guide electromagnets 12 on the four edges can be used to stop and park the yarn carrier assemblies 23 in place.

The yarn carrier base 14 further includes an upper mounting block 16 and a lower sliding block 17, the support post 18 is located between the upper mounting block 16 and the lower sliding block 17, and a bottom surface of the lower sliding block 17 has a boat-bottom shape with a lower middle section and gradually raised ends, so as to match the guide groove 11. The support post 18 is cylindrical, and a front end of each finger portion 22 is an arc-shaped recess adapted to the cylindrical support post 18. One or more yarn carriers 5 may be mounted on the upper mounting block 16. By increasing or decreasing the number of the yarn carriers 5, a number of yarns in the braiding machines can be adjusted accordingly.

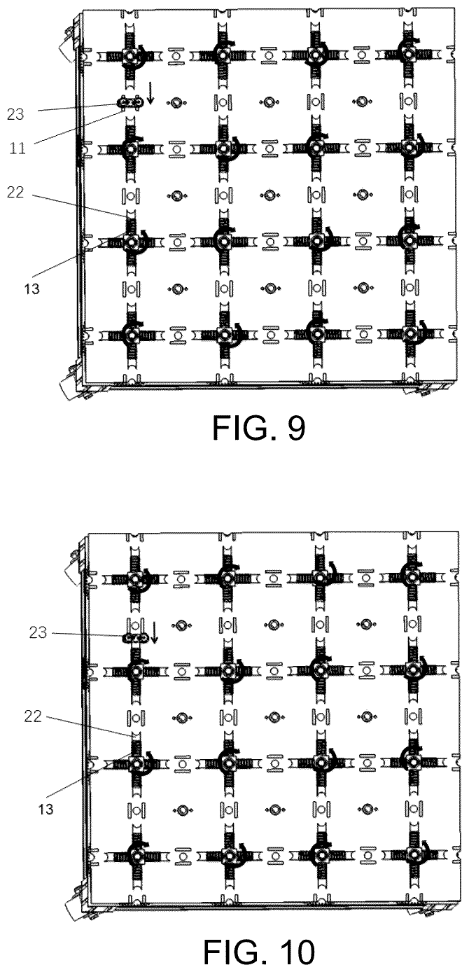

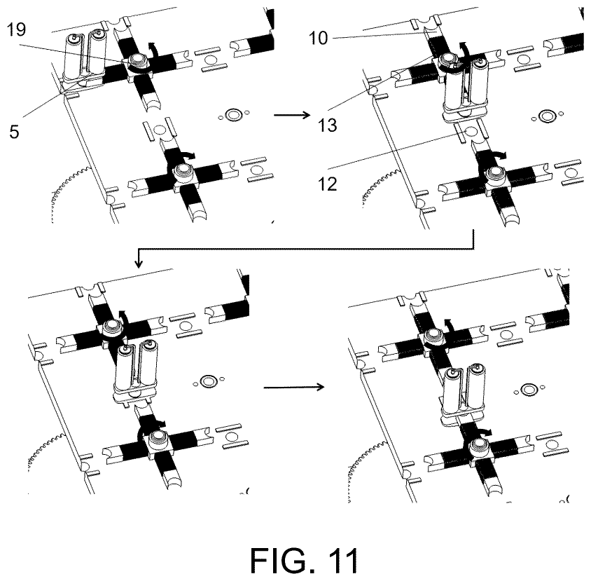

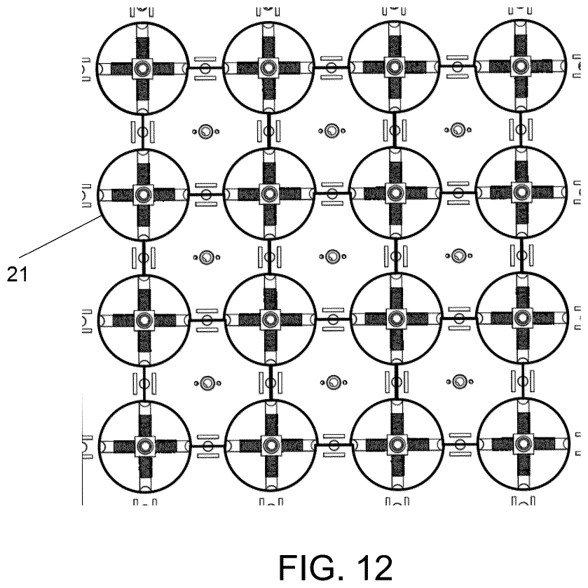

In the case where the guide grooves 11 are arranged, the present disclosure provides a control method for preparing a three-dimensional structured fabric by the electromagnetic stepping three-dimensional rotary braiding machine as follows:
S1. as shown in FIG. 7, arranging the yarn carrier assembly 23 at an end portion of the cross-shaped fork 10, activating an electromagnetic structure of the finger portion 22 of the cross-shaped fork 10, supplying direct current to the solenoid 13 and gradually increasing the current until the yarn carrier assembly 23 is tightly attracted by the current;
S2. as shown in FIG. 8, driving the motion mechanism to drive the cross-shaped forks 10 to rotate synchronously by 90° by activating the servo motor 20 mounted on the frame, and the to drive the yarn carrier assemblies 23 to rotate by 90° together with the cross-shaped forks 10;
S3. as shown in FIG. 9, activating electromagnet 12 located in the guide groove 11 until the yarn carrier assembly 23 slides from the finger portion 22 of the cross-shaped forks 10 to the guide groove 11;
S4. as shown in FIG. 10, de-energizing the electromagnet structure at the finger portion 22 of the cross-shaped forks 10 in the step S3, energizing the electromagnet structure of the adjacent finger portions 22 of the cross-shaped forks 10 and gradually increasing the current until the current until the yarn carrier assembly 23 is tightly attracted by the current;
S5. as shown in FIG. 11, lifting a fabric height by the fabric traction device 1 according to the design requirements of the fabric after one braiding cycle is completed; and
S6. repeating the above mechanical steps in a predefined trajectory by the braiding machine to form a fabric structure, and FIG. 12 shows a trajectory range 21 that the yarn carrier assemblies may move.
S7. repeating the above mechanical steps in a predefined trajectory by the braiding machine to form a fabric structure.

The power supply system to the electromagnet is controlled by the electronic control system 3 of the braiding machine, and the electromagnet of the electromagnet structure at the finger portion 22 of any of the cross-shaped forks 10 and the electromagnet 12 of the guide groove 11 can be selectively energized or de-energized according to the set parameters.

The fabric lifting height in the above step has a functional relationship with the braiding parameters of the braiding machine, and is constrained by the following equation:

$$v = \frac{H}{( \frac{0.5 π}{W} + Δ {T}_{1} + Δ {T}_{2} )}$$

where v denotes a fabric lifting speed of the fabric traction device 1, H denotes a fabric pitch height, W denotes a rotation angular velocity of the cross-shaped fork 10, ΔT₁ denotes a time duration during which the electromagnet 13 at four ends of each cross-shaped forks 10 are energized to generate magnetic force, and ΔT₂ denotes a time duration during which the electromagnets 12 in the guide grooves are energized to generate magnetic force.

When a control method id provided for an alternative embodiment of the braiding machine in which no guide groove 11 is arranged, the step S3 of the above control method can be deleted. In this case, the yarn carrier assembly may directly move from one finger portion to another adjacent finger portion to achieve braiding control, which will not be repeated herein.

There are various ways to implement the present disclosure, and what is described above is merely preferred implementations of the present disclosure. It should be pointed out that those of ordinary skill in the art may also make some improvements and modifications without departing from the principle of the present disclosure, and these improvements and modifications should also fall within the scope of protection of the present disclosure.

1. An electromagnetic stepping three-dimensional rotary braiding machine, comprising an upper support plate, a plurality of cross-shaped forks mounted on the upper support plate, a drive mechanism for driving the cross-shaped forks to rotate, and a plurality of yarn carrier assemblies cooperating with the cross-shaped forks; wherein
the plurality of cross-shaped forks are evenly mounted in rows and columns on the upper support plate, each cross-shaped fork comprises a central rotating shaft perpendicular to a surface of the upper support plate and inserted into the upper support plate, and finger portions extending from the central rotating shaft in four directions; each finger portion is an electromagnet structure and is independently controlled for power supply; and the drive mechanism is configured to drive all the cross-shaped forks to rotate simultaneously, and rotation directions of two adjacent cross-shaped forks are opposite; and
each yarn carrier assembly comprises a yarn carrier base and a yarn carrier mounted on the yarn carrier base, and a support post made of ferromagnetic material is disposed at a center of the yarn carrier base to cooperate with the finger portions; and when the finger portions of the cross-shaped forks are energized, magnetic force is generated to attract the support post, and the yarn carrier base is driven to rotate.

2. The electromagnetic stepping three-dimensional rotary braiding machine according to claim 1, wherein a plurality of guide grooves are formed on the upper support plate, one guide groove is arranged between every two adjacent cross-shaped forks, and one guide electromagnet is arranged at a bottom of each guide groove; and when the finger portions of the cross-shaped forks are energized, the support post is driven to rotate to a position facing the guide groove, the guide electromagnet is energized to generate magnetic force greater than that of the finger portions, and the support post is attracted into the guide groove.

3. The electromagnetic stepping three-dimensional rotary braiding machine according to claim 2, wherein the drive mechanism comprises a motor located below the upper support plate and a plurality of gear shafts arranged in rows and columns and parallel to one another; and one gear shaft is coaxially connected to the central rotating shaft of one corresponding cross-shaped fork, each gear shaft is provided with one gear, two adjacent gears in each row or each column mesh with each other, and one of the gear shafts, as a driving gear shaft, is connected to a motor output shaft.

4. The electromagnetic stepping three-dimensional rotary braiding machine according to claim 1, further comprising a fabric traction device located above the yarn carrier assemblies for pulling yarns wound on the yarn carrier assemblies.

5. The electromagnetic stepping three-dimensional rotary braiding machine according to claim 2, wherein the yarn carrier base further comprises an upper mounting block and a lower sliding block, the support post is located between the upper mounting block and the lower sliding block, and a bottom surface of the lower sliding block has a boat-bottom shape with a lower middle section and gradually raised ends to match the guide groove.

6. The electromagnetic stepping three-dimensional rotary braiding machine according to claim 5, wherein the support post is cylindrical, and a front end of each finger portion is an arc-shaped recess adapted to the cylindrical support post.

7. The electromagnetic stepping three-dimensional rotary braiding machine according to claim 3, further comprising a lower support plate located below the upper support plate, a bottom of each gear shaft is mounted on the lower support plate via bearings, support shafts are arranged between the upper support plate and the lower support plate, bottoms of the support shafts are fixed to the lower support plate, tops of the support shafts are fixed to the upper support plate, and a through hole is formed in a center of each support shaft for introducing an axial yarn.

8. A control method for the electromagnetic stepping three-dimensional rotary braiding machine according to claim 1, comprising following steps:
S1. arranging the yarn carrier assemblies on the upper support plate according to braiding requirements;
S2. activating the electromagnetic structure of one finger portion to attract the yarn carrier assemblies;
S3. driving all the cross-shaped forks to rotate by 90° at the same time;
S4. de-energizing the electromagnet structure of the energized finger portion in the step S2, and energizing the electromagnet structure of the finger portion of another cross-shaped fork adjacent to the de-energized one until the yarn carrier assemblies slide toward the energized finger portion;
S5. raising a fabric height according to fabric structural design requirements; and
S6. repeating the above mechanical steps in a predefined trajectory by the braiding machine to form a fabric structure.

9. A control method for the electromagnetic stepping three-dimensional rotary braiding machine according to claim 2, comprising following steps:
S1. arranging the yarn carrier assemblies on the upper support plate according to braiding requirements;
S2. activating the electromagnetic structure of one finger portion to attract the yarn carrier assemblies;
S3. driving all the cross-shaped forks to rotate by 90° simultaneously;
S4. activating an electromagnet in a guide groove until the yarn carrier assemblies slide from the finger portion into the guide groove;
S5. de-energizing the electromagnet structure of the energized finger portion in the step S2, and energizing the electromagnet structure of the finger portion of another cross-shaped fork adjacent to the de-energized one until the yarn carrier assemblies slide toward the energized finger portion;
S6. raising a fabric height according to fabric structural design requirements; and
S7. repeating the above mechanical steps in a predefined trajectory by the braiding machine to form a fabric structure.

10. The control method for the electromagnetic stepping three-dimensional rotary braiding machine according to claim 9, wherein the fabric height in the step S6 is constrained by following equation:
$$v = \frac{H}{( \frac{0.5 π}{W} + Δ {T}_{1} + Δ {T}_{2} )}$$
wherein v denotes a fabric lifting speed of a fabric traction device, H denotes a fabric pitch height, W denotes a rotation angular velocity of the cross-shaped fork, ΔT₁ denotes a time duration during which the electromagnet structure of the finger portion is energized to generate magnetic force, and ΔT₂ denotes a time duration during which the electromagnet in the guide groove is energized to generate magnetic force.
